(19) United States
(12) Patent Application Publication
(10) Pub. No.: US 2008/0289459 A1
(43) Pub. Date: Nov. 27, 2008

(54) Screw Holding and Driving-Control Apparatus and Method

(76) Inventor: Bruce B. Yablon, Katonah, NY (US)

Correspondence Address: LAW OFFICE OF JAY R. YABLON, 910 NORTHUMBERLAND DRIVE, SCHENECTADY, NY, 12309-2814, US

(21) Appl. No.: 12/187,333

(22) Filed: Aug. 6, 2008

Related U.S. Application Data
(60) Provisional application No. 60/968,427, filed on Aug. 28, 2007.

(51) Int. Cl. B25B 23/12

(52) U.S. Cl. 81/451

(57) ABSTRACT

An improved screw holding and driving device that enables the user to control the screw depth for use with power drills/drivers. The tool has a screw holding/driving device with an optional inset magnet mating with a standard screw driving bit or screw and a sliding outer sleeve with a depth-controlling flared head to absorb and distribute driving force and a depth control depth control stop at a selected longitudinal position based on the controlled depth to which it is desired to drive the screw. The sleeve is cable of complete free rotation and the depth control nut and retaining ring allow the user to set the depth to allow minimal surface penetration/dimpling for materials like drywall board or set above the material for fine carpentry to allow hand driving to complete screw attachment.

### CROSS-REFERENCE TO RELATED APPLICATION

This application claims benefit of pending U.S. application 60/968,427 filed Aug. 28, 2007.

### BACKGROUND OF THE INVENTION

The invention relates to a device for holding screws securely in contact with a driving bit during positioning and driving of the screw while simultaneously controlling the depth that the screw is driven to prevent damage to the material being fastened and over-driving of the screw.

Screw holding and driving devices are well known in the art as shown by U.S. Pat. No. 772,912 to Allam; U.S. Pat. No. 2,235,235 to Price; U.S. Pat. No. 2,902,071 to Poynte et al. U.S. Pat. No. 3,392,767 to Stillwagon; U.S. Pat. No. 3,707,894 to Stillwagon; U.S. Pat. No. 3,739,825 to Knox; U.S. Pat. No. 4,140,161 to Russo; and U.S. Pat. No. 4,736,658 to Jore.

Presently, carpenters and builders often use a drill/driver tool such as is disclosed in U.S. Pat. No. 4,736,658 with a sleeve and magnet to hold and control the screw while driving the screw into materials to be fastened together. However, there is no way when using such devices to control the depth except by the user's dexterous control of the drill/driving device and the user's ability to stop the rotation at the proper depth to prevent damage to the materials being fastened and overdriving of the screw.

From the above it can be seen that the need exists for a simple, easy to set and use device not only to control the screw being driven, but also, in simultaneous combination therewith, the depth to which the screw is driven. In addition, the need exists for the device to be used repeatedly while setting the screw at a uniform and consistent depth in a repetitive manner. Furthermore, the device should have, for example not limitation, a hex drive shaft to attach/retrofit the device to almost any hexagonal drill/driver currently manufactured. Many devices today accept and use widely-available commercial screwdriver bits having, e.g., a hexagonal shank. These bits are regularly used by carpenters as replacement bits with many head types from slotted to Phillips to square head to Torq. It is desirable to allow use of, and quick replacement of, these and other bits.

### SUMMARY OF THE INVENTION

The present invention is an improved device for holding a screw during positioning and driving the screw while simultaneously controlling the drive depth of the screw without requiring any special dexterity by the user. The invention has the advantage of having a free-spinning sleeve with an optional depth-control flared head to stop the screw from driving beyond the depth required by the user.

In order to accomplish this advantage, means are provided to set and hold the amount of return by the sleeve before the torque driving the screw is released preventing the screw from being over-driven. In one preferred exemplary embodiment, there is a hex nut with two ball detents, which can be positioned on the shaft of the screw driving device to any position along the shaft of the driving device. There is also a lock retaining ring with two notches that fits into two grooves in the screw-driving device that slides over the nut from the sleeve side of the device to prevent rotation or movement of the nut from either vibration or from the force of the spinning sleeve pushing against the nut. To prevent the nut from coming off the back of the driving device, there is a tensioned, hardened steel “C” ring set into a groove at the back end of the device. The lock retaining ring has grooves around the outside to allow easy attachment to and sliding off of the depth control nut by the user with bare hands or gloves. The back end of the sleeve is narrower than the rest of the sleeve and the front end of the driving device is wider than the rest of the driving device to prevent the sleeve from coming off the front end of the driving device. The head of the sleeve is flared to distribute weight and force and prevent damage to the material the screw is being driven into. It is possible, optionally, for the flare end to comprise a removable/replaceable rubber, leather, plastic or other cushioning material as well, to further prevent damage to the material being fastened. It is also possible, optionally, to use many other means to set the depth of the sleeve return including, but not limited to, a round ring with a hex set-screw also shown as an alternative preferred exemplary embodiment.

In sum, disclosed herein is an apparatus and related method for driving a screw to a controlled depth while simultaneously stabilizing the screw during the driving, comprising: a screw control sleeve for stabilizing the screw while the screw is being driven; a screw driving device situated longitudinally and slidably within the screw control sleeve, configured to mate proximate a forward end thereof with a standard screw driver bit for driving the screw or directly with the screw, and configured to be rotationally driven proximate a rearward end thereof by a rotational driving device; and a depth control stop adjustably fixed by the user at a selected longitudinal position of the screw driving device based on the controlled depth to which a user of the apparatus desires to drive the screw; wherein: when the screw driving device is driven forward by the rotational driving device, a portion of the depth control stop comes to butt against a portion of the screw control sleeve, such that the screw driving device cannot be driven forward any further and hence the screw cannot be driven forward any further.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 shows an elevational view of the screw/depth control driver tool of a preferred exemplary embodiment of the invention, with the lock retaining ring engaged to the depth control setting nut.

FIG. 2 shows an elevational view of the screw/depth control driver tool of the FIG. 1 embodiment with the lock retaining ring disengaged from the depth control setting nut allowing adjustment to the driving depth.

FIG. 3 shows a cross section view along line 3-3 shown in FIG. 1.

FIG. 4 shows an elevational view of a screw/depth control driver tool in an alternative preferred exemplary embodiment of the invention, with a depth control setting ring and set screw.

FIG. 5 shows an enlarged cross section along a line 5-5 in FIG. 4 illustrating the depth control setting ring and hex set screw of this alternative preferred exemplary embodiment.

FIG. 6 shows an enlarged cross section along a line 6-6 in FIG. 1 illustrating the depth control setting nut and the lock retaining ring engaged to hold the depth control setting nut.

FIG. 7 shows an enlarged cross section along lines 7-7 in FIG. 2 illustrating the depth control setting nut and the lock retaining ring disengaged to allow setting of the depth control setting nut to a user defined depth.

FIG. 8 shows an enlarged cross section along lines 8-8 in FIG. 7 of the depth control setting nut including the springs and detent balls.

FIG. 9 shows an enlarged elevational view of a cross section along lines 9-9 in FIG. 7 of the lock retaining ring and notches used to prevent rotation.

### DETAILED DESCRIPTION

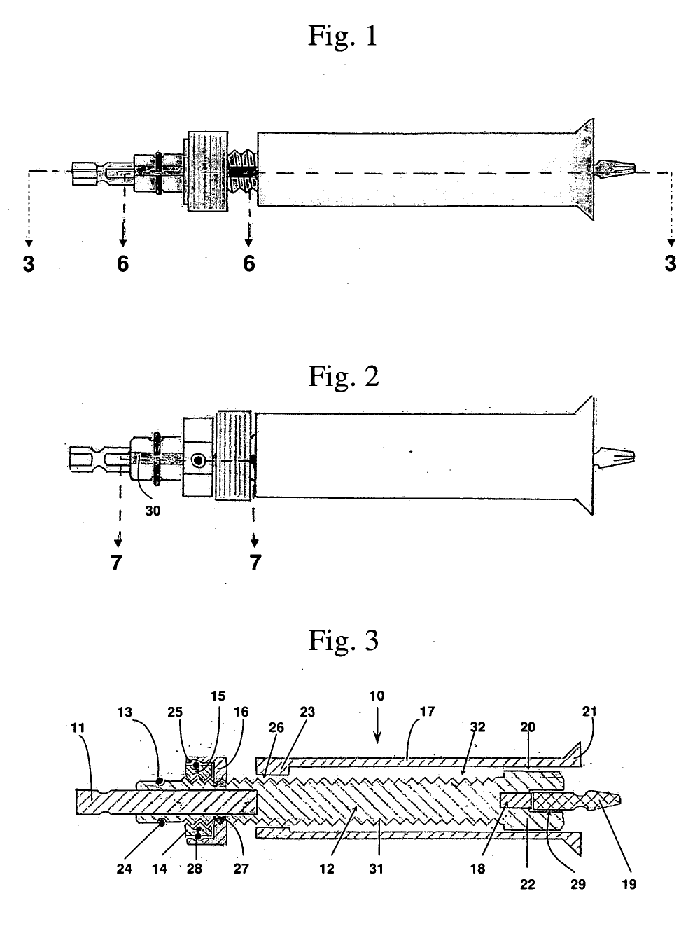

In the drawings, FIGS. 1 through 3 show a screw/depth control driver device (an apparatus for driving a screw to a controlled depth while simultaneously stabilizing the screw during the driving) 10 which includes a screw control sleeve 17 which is sized to slidably but closely fit longitudinally over a screw driving device 12 as illustrated. The sleeve 17 has a narrow passage 26 at the back end and an enlarged end 23 which extends into a second wider passage 32 and engages against the wider front end 22 on the screw driving device 12. The design of sleeve 17 is intended to prevent removal from the front end of the screw driving device 12 and is designed to allow sleeve 17 to slidably but closely fit the screw driving device 12. It is intended that sleeve 17 can rotate freely on the screw driving device 12 allowing the user to grasp and hold sleeve 17 while driving a screw. The space between sleeve 17 and the screw driving device 12 at enlarged end 23 is designated 26. The space between sleeve 17 and the screw driving device 12 at wider front end 22 is designated 20. The screw control sleeve 17 has a flared head 21 to spread and absorb toque and control depth by contacting the surface into which the screw is to be driven and prevent damage to the materials being fastened. The screw driving device 12 has a thread pattern applied along most of its length indicated as 31 to allow a depth control stop comprising threaded depth control setting nut 14 to be moved forward or backwards and held along the screw driving device 12 to control the depth of the screw being driven.

The screw/depth control driver device 10 has the depth control setting nut 14 containing detent balls 28 and springs 15 and a lock-retaining ring 16. Lock retaining ring 16 has two protrusions 27 on opposite sides that fit into two (at least one) longitudinally-oriented grooves 30 shown in FIG. 2, cut partly into the opposite sides of the screw driving device 12. It will be appreciated by anyone of ordinary skill in the art that the configuration of the detent balls 28 and springs 15 and protrusions 27 may easily be reversed, with lock retaining ring 16 comprising the detent balls 28 and springs 15 and depth control setting nut 14 comprising the protrusions 27, and that this trivial variation is understood to be within the scope of this disclosure and its associated claims. The foregoing allow depth control setting nut 14 to be moved and held forward or backwards along the screw driving device 42 to control the depth of the screw being driven, and to prevent its rotation once the desired driving depth has been set. The protrusions 27 prevent the lock retaining ring 16 from rotating and when engaged over the depth control setting nut 14, prevent the depth control setting nut from rotating, thus holding the user's preset depth until changed by the user. The lock retaining ring 16 has a groove on the inside designated 25 to allow the detent balls 28 set into the depth control setting nut 14 to be engaged into the lock retaining ring 16 to hold the lock retaining ring 16 into place over the depth control setting nut 14. The depth control setting nut 14 and the lock retaining ring 16, preferably, comprise hardened steel or similar material to provide the desired functions of strength and durability.

Screw driving device 12 has a semicircular groove 24 completely around the circumference, which allows the tight fit of a hardened steel “C” ring 13 set into groove 24 to prevent the depth control nut 14 from being removed from the device. It will be understood that this is merely one non-limiting example of how to prevent this removal of depth control nut 14. Screw driving device 12 is permanently attached to a, e.g., hex drill/drive shaft 11 to allow attachment to most any rotational driving device. This includes retrofitting to a pre-existing rotational driving device such as a drill, etc., as well as integral fabrication into a single unit which includes the rotational driving device permanently integrated with the drive shaft. Furthermore, there is an optional magnet 18 permanently set into the drive end of the screw driving device 12 and a, e.g., hex head opening 29 sized to closely fit a standard screw driver bit 19.

To use the device, the user insets a screw into the end of the device 10 onto the bit 19 and slides the sleeve 17 forward over the screw. While less preferred, though still within the scope of this disclosure and the associated claims, bit 19 may be fashioned as an integral component of this device, rather than being separate and attachable. With the depth control lock retaining ring 16 slid forward to disengage the depth control setting nut 14 as in FIG. 2, the depth control setting nut 14 can be rotated clockwise (i.e., moved forward) to reduce the amount of driving depth of the screw being driven by the device 10. Furthermore, the depth control setting nut 14 can be rotated anti-clockwise (i.e., moved rearward) to increase to amount of the driving depth of a screw being driven by the device 10. (It is to be understood that clockwise versus counterclockwise rotation in relation to forward versus rearward movement is immaterial to the invention and that either relation is regarded to be within the scope of this disclosure and its associated claims.) When a desired depth is set, the lock retaining ring 16 is slid back over the depth control setting nut 14 as in FIG. 1 to prevent the depth control setting nut 14 from turning, maintaining the correct driving depth. The sleeve 17 is then slid completely forward until the flared end 21 is beyond, even with or just short of the end of the screw and the user can then place the screw against the material being fastened and drive the screw by rotating with a rotational driving device, e.g., drill, wherein rotational motion is transferred from the drill/drive shaft 11 then to the screw driving device 12 and the bit 19 utilizing the mating (e.g., hexagonal shaped) parts to drive the screw. To control positioning, the sleeve 17 can be held and will not rotate while the screw is being driven. Referring to FIG. 3, it should be apparent that it is the distance between the forward end of the depth control setting nut 14 and lock retaining ring 16 combination, and the rear-most portion of sleeve 17, as well as the overall lengths of the screw control sleeve 17 and the screw driving device 12, which then control the driving depth, because once the depth control setting nut 14 and lock retaining ring 16 combination come into contact with sleeve 17, it is no longer possible for the screw to be driven forward any further.

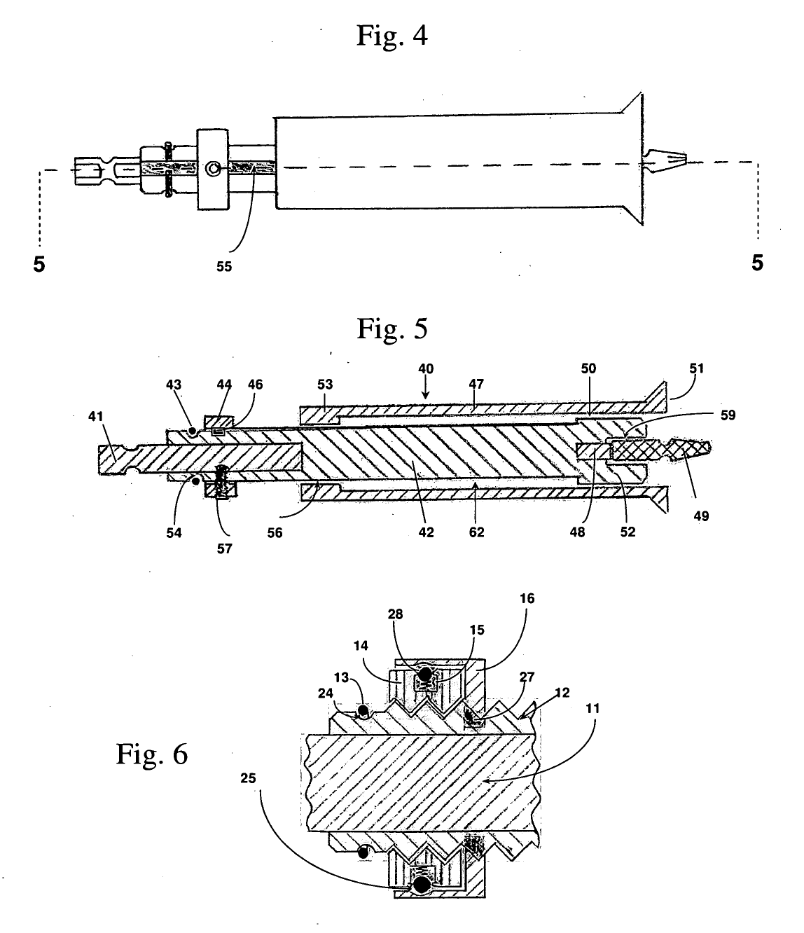

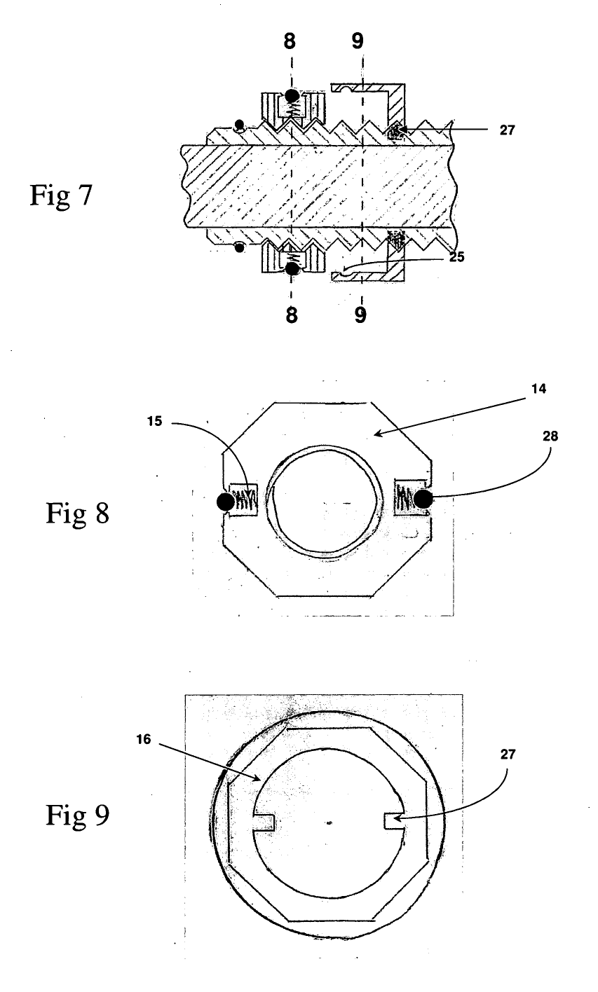

An alternative exemplary embodiment of the screw/depth control driving device described above is shown in FIGS. 4 and 5. These figures show a screw/depth control driver device 40 which includes the screw control sleeve 47 which is sized to slidably but closely fit longitudinally over the screw driving device 42 as illustrated. The sleeve 47 has a narrow passage 56 at the back end and an enlarged end 53 which extends into a second wider passage 62 and engages against the wider front end 52 on the screw driving device 42. The design of sleeve 47 is intended to prevent removal from the front end of the screw driving device 42 and is designed to allow sleeve 47 to slidably but closely fit the screw driving device 42. It is intended that sleeve 47 can rotate freely on the screw driving device 42 allowing the user to grasp and hold the sleeve while driving a screw. The space between sleeve 47 and the screw driving device 42 at enlarged end 53 is designated 56. The space between sleeve 47 and the screw driving device 42 at wider front end 52 is designated 50. The screw control sleeve 47 has a flared head 51 to spread and absorb toque and control depth by contacting the surface into which the screw is to be driven and prevent damage to the materials being fastened. The screw driving device 42 has two (at least one) longitudinally-oriented grooves along its length indicated as 55 in FIG. 4, to allow a depth control stop comprising depth control setting ring 44 to be moved and held forward or backwards along the screw driving device 42 to control the depth of the screw being driven, and to prevent its rotation once the desired driving depth has been set.

The screw/depth control driver device 40 has the depth control setting ring 44 containing a, e.g., hex set screw 57 on one side and a protrusion 46 on the other side. The set screw 57 and the protrusion 46 both set into the grooves 55 cut partly into the all or part of the entire length on opposite sides of the screw driving device 42. The protrusions 46 and the set screw 57 prevent the depth control setting ring 44 from rotating when set to a desired position along the screw driving device 42, thus holding the user's preset depth until changed by the user. The depth control setting ring 44 and set screw 57, preferably, comprise hardened steel or similar material to provide the desired functions of strength and durability.

The screw driving device 42 has a semicircular groove completely around the circumference designated 54 which allows the tight fit of a hardened steel “C” ring 43 set into groove 54 to prevent the depth control ring 44 from being removed from the device. Again, many alternatives for preventing removal will occur to anyone of ordinary skill and are regarded to be within the scope of this disclosure and it associated claims. The screw driving device 42 is permanently attached onto a, e.g., hex drill/drive shaft 41 to allow attachment to most any rotational driving device such as a drill. This includes retrofitting to a pre-existing rotational driving device such as a drill, etc., as well as integral fabrication into a single unit which includes the rotational driving device permanently integrated with the drive shaft. Furthermore, there is an optional magnet 48 permanently set into the drive end of the screw driving device 42 and a, e.g., hex head opening 59 sized to closely fit a standard screw driver bit 49.

To use the device, the user insets a screw into the end of the device 40 onto the bit 49 and slides the sleeve 47 forward over the screw. Again, while less preferred, though still within the scope of this disclosure and the associated claims, bit 49 may be fashioned as an integral component of this device, rather than being separate and attachable. With the hex set screw 57 loosened slightly to disengage the depth control setting ring 44, the depth control setting ring 44 can be moved forward to reduce the amount of driving depth of the screw being driven by the device 40. Furthermore, the depth control setting ring 44 can be moved rearward to increase to amount of the driving depth of a screw being driven by the device 40. When a desired depth is set, the hex set screw 57 is tightened to prevent the depth control setting ring 44 from sliding, maintaining the correct driving depth, while the engagement of 57 and 46 into grooves 55 prevents depth control setting ring 44 from rotating. The sleeve 47 is then slid completely forward until the flared end 51 is beyond, even with or just short of the end of the screw and the user can then place the screw against the material being fastened and drive the screw by rotating with a rotational driving device, e.g., drill, wherein rotational motion is transferred from the drill/drive shaft 41 then to the screw driving device 42 and the bit 49 utilizing the mating, e.g., hexagonal shaped parts to drive the screw. To control positioning, the sleeve 47 can be held and will not rotate while the screw is being driven. Referring to FIG. 5, it should be apparent that it is the distance between the forward end of depth control setting ring 44 and the rear-most portion of sleeve 47, as well as the overall lengths of the screw control sleeve 47 and the screw driving device 42, which then control the driving depth, because once the depth control setting ring 44 comes into contact with sleeve 47, it is no longer possible for the screw to be driven forward any further.

It is possible in all embodiments of the screw/depth control driver device to have the flared end designed to allow the application of different materials such as plastic, rubber, leather etc. to further prevent marring, damage or scuffing of the materials being fastened, as required by the user.

While only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. An apparatus for driving a screw to a controlled depth while simultaneously stabilizing the screw during the driving, comprising:
a screw control sleeve for stabilizing the screw while the screw is being driven;
a screw driving device situated longitudinally and slidably within said screw control sleeve, configured to mate proximate a forward end thereof with a standard screw driver bit for driving the screw or directly with the screw, and configured to be rotationally driven proximate a rearward end thereof by a rotational driving device; and
a depth control stop adjustably fixed by the user at a selected longitudinal position of said screw driving device based on the controlled depth to which a user of said apparatus desires to drive the screw; wherein:
when said screw driving device is driven forward by the rotational driving device, a portion of said depth control stop comes to butt against a portion of said screw control sleeve, such that said screw driving device cannot be driven forward any further and hence the screw cannot be driven forward any further.

2. The apparatus of claim 1, further comprising a drive shaft for mating with and being removably attached to the rotational driving device.

3. The apparatus of claim 1, further comprising a drive shaft permanently integrated with the rotational driving device.

4. The apparatus of claim 1, said screw control sleeve comprising a flared head proximate a forward end thereof.

5. The apparatus of claim 1, further comprising at least one detent ball for adjustably fixing said depth control stop.

6. The apparatus of claim 1, further comprising a set screw for adjustably fixing said depth control stop.

7. The apparatus of claim 1, said screw driving device further comprising at least one longitudinally-oriented groove for sliding said depth control stop forward and backward during adjustment and for preventing said depth control stop from rotating once said depth control stop has been fixed.

8. The apparatus of claim 1, said depth control stop comprising a depth control setting nut and lock retaining ring for retaining said depth control setting nut in place once said depth control setting nut has been slid to said selected longitudinal position.

9. The apparatus of claim 8, said depth control setting nut and lock retaining ring further comprising at least one detent ball for adjustably fixing said depth control setting nut and lock retaining ring.

10. The apparatus of claim 8, said screw driving device further comprising at least one longitudinally-oriented groove for sliding said lock retaining ring forward and backward during adjustment and for preventing said lock retaining ring from rotating once said depth control stop has been fixed.

11. The apparatus of claim 1, said depth control stop comprising a depth control setting ring.

12. The apparatus of claim 11, said depth control setting ring comprising a set screw for adjustably fixing said depth control setting ring.

13. The apparatus of claim 11, said screw driving device further comprising at least one longitudinally-oriented groove for sliding said depth control setting ring forward and backward during adjustment and for preventing depth control setting ring from rotating once said depth control setting ring has been fixed.

14. The apparatus of claim 1, said forward end of said screw driving device comprising a magnet proximate thereto, for holding screws comprising magnetized materials.

15. A method for driving a screw to a controlled depth while simultaneously stabilizing the screw during the driving, comprising:
adjustably fixing a depth control stop at a selected longitudinal position of a screw driving device situated longitudinally and slidably within a screw control sleeve, based on the controlled depth to which it is desired to drive the screw;
stabilizing the screw while the screw is being driven, using said screw control sleeve; and
driving said screw driving device forward to drive the screw forward, using a rotational driving device, such that a portion of said depth control stop comes to butt against a portion of said screw control sleeve, such that said screw driving device cannot be driven forward any further and consequently the screw cannot be driven forward any further.

16. The method of claim 15, further comprising removably mating a drive shaft of said screw driving device the rotational driving device.

17. The method of claim 15, further comprising permanently integrating a drive shaft of said screw driving device with the rotational driving device.

18. The method of claim 15, further comprising providing a flared head proximate a forward end of said screw control sleeve.

19. The method of claim 15, further comprising adjustably fixing said depth control stop using at least one detent ball therefor.

20. The method of claim 15, further comprising adjustably fixing said depth control stop using a set screw therefor.

21. The method of claim 15, further comprising sliding said depth control stop forward and backward during adjustment and preventing said depth control stop from rotating once said depth control stop has been fixed, using at least one longitudinally-oriented groove of said screw driving device.

22. The method of claim 15, further comprising:
sliding a depth control setting nut of said depth control stop to said selected longitudinal position; and
retaining said depth control setting nut in place using a lock retaining ring of said depth control stop.

23. The method of claim 22, further comprising:
adjustably fixing said depth control setting nut and lock retaining ring using at least one detent ball thereof.

24. The method of claim 22, further comprising sliding said lock retaining ring forward and backward during adjustment and preventing said lock retaining ring from rotating once said depth control stop has been fixed, using at least one longitudinally-oriented groove of said screw driving device.

25. The method of claim 15, said depth control stop comprising a depth control setting ring.

26. The method of claim 25, further comprising adjustably fixing said depth control setting ring using a set screw thereof.

27. The method of claim 25, further comprising sliding said depth control setting ring forward and backward during adjustment and preventing depth control setting ring from rotating once said depth control setting ring has been fixed, using at least one longitudinally-oriented groove of said screw driving device.

28. The method of claim 15, further comprising holding screws comprising magnetized materials using a magnet proximate said forward end of said screw driving device.
